(19) United States
(12) Patent Application Publication
(10) Pub. No.: US 2025/0153259 A1
(43) Pub. Date: May 15, 2025

(54) THREAD MILLING TOOL

(71) Applicant: CERATIZIT Besigheim GmbH, Besigheim (DE)

(72) Inventors: Gabriele DURST, Besigheim (DE); Wolfgang HEIDUSCH, Besigheim (DE)

(21) Appl. No.: 18/839,502

(22) PCT Filed: Sep. 13, 2022
(86) PCT No.: PCT/EP2022/075338

§ 371 Date: Aug. 19, 2024

(30) Foreign Application Priority Data
Feb. 18, 2022 (EP) 22157389.2

(51) Int. Cl. B23G 5/18; B23B 51/08

(52) U.S. Cl. CPC B23G 5/188; B23B 51/08; B23G 2200/143

(57) ABSTRACT

A thread milling tool extends along an axis of rotation and contains a thread milling section and a drill tip adjoining the thread milling section. The thread milling section has three cutting flutes and at least one thread milling tooth, while the drill tip has three main cutting edges, each of which reaches a main cutting circle when viewed in parallel to the axis of rotation. The main cutting circle defines a drilling diameter that can be produced by the drill tip. Each main cutting edge has a main cutting surface that is connected to one cutting flute of the cutting flutes and reaches the main cutting circle at a respective radial main cutting angle when viewed in parallel to the axis of rotation, and at least one radial main cutting angle of the radial main cutting angles is positive.

The present invention relates to a drill thread milling cutter, which extends along an axis of rotation and has a thread milling portion and a drill tip adjoining the thread milling portion, wherein the thread milling portion has three flutes and a plurality of thread milling teeth, wherein the drill tip has three lips which each reach a lip cutting circle in a viewing direction parallel to the axis of rotation, wherein the lip cutting circle defines a drilling diameter that can be produced by the drill tip, wherein each lip has a lip rake face which is connected to one flute of the flutes and which reaches the lip cutting circle at a radial lip rake angle in a viewing direction parallel to the axis of rotation.

U.S. Pat. No. 4,651,374 A discloses a two-edged drill thread milling cutter. The known drill thread milling cutter allows a drilled hole, generally a cylindrical drilled hole, to first be introduced into a workpiece. For this purpose, the known drill thread milling cutter has two drilling cutting edges, by means of which the drilled hole can be produced. After the drilled hole has been introduced, the known drill thread milling cutter is radially advanced, i.e. moved from the center of the drilled hole into a position parallel to the axis of the drilled hole. Milling teeth are arranged on the shaft of the known drill thread milling cutter, by means of which milling teeth a thread can then be introduced into the drilled hole by means of circular thread milling. The milling teeth jointly engage into the wall of the drilled hole, wherein, with rotation of the known drill thread milling cutter and with simultaneous performance of a screw movement of the known drill thread milling cutter, the thread is produced.

Problems occur if materials that produce long chips, such as wrought aluminum alloys, are machined using the known drill thread milling cutter, because the chips produced during drilling are so long that they soon can no longer be sufficiently transported out of the drilled hole. As a result, these chips contact the milling teeth and sometimes lodge themselves between the milling teeth, whereby the milling teeth are damaged. In addition, in the case of the known drill thread milling cutter, there is a need to increase the advancing speed during drilling.

It is the object of the present invention to provide a drill thread milling cutter which, for the machining of materials that produce long chips, has a longer service life and greater advancing speed.

The object of the present invention is achieved by the subject matter of claim 1. Advantageous developments of the invention can be found in the dependent claims, which can be freely combined with one another, and in the description, the exemplary embodiments and the drawing.

The drill thread milling cutter extends along an axis of rotation and has a thread milling portion and a drill tip adjoining the thread milling portion, wherein the thread milling portion has three flutes and a plurality of thread milling teeth, wherein the drill tip has three lips which each reach a lip cutting circle in a viewing direction parallel to the axis of rotation, wherein the lip cutting circle defines a drilling diameter that can be produced by the drill tip, wherein each lip has a lip rake face which is connected to one flute of the flutes and which reaches the lip cutting circle at a radial lip rake angle in a viewing direction parallel to the axis of rotation, wherein at least one radial lip rake angle of the radial lip rake angles is positive.

As a result of the at least one positive radial lip rake angle, during drilling the chips are more strongly compressed in the region of the drill tip and, even in the machining of materials that produce long chips, are broken. Consequently, the chips can be better transported out of the region of the drill tip, which increases the service life and also the advancing speed, because at least less chip clearing or even no more chip clearing is required during drill thread milling. The advancing speed is additionally increased by virtue of the fact that the drill tip has three lips. The chip production in the case of three lips, which is greater than the chip production in the case of two lips, is better managed as a result of the improved chip breaking, since the chips are broken shorter.

Preferably, the radial lip rake angle of each lip rake face is positive, because then the described advantages are achieved at all three lips.

The radial lip rake angle is defined according to the common convention. Thus, the radial lip rake angle has a first angle leg, which is a tangent of the lip rake face where the lip rake face touches the lip cutting circle in a viewing direction parallel to the axis of rotation. The radial lip rake angle has a second angle leg, which is oriented such that its radial extension with respect to the axis of rotation would intersect the axis of rotation perpendicularly to the axis of rotation.

The lip rake angle is measured on the side of the axis of rotation in a viewing direction parallel to the axis of rotation and is, according to the common convention, positive if the second angle leg leads, with respect to a cutting-active direction of rotation of the drill tip, the lip rake face where the lip rake face, coming from the point at which it touches the lip cutting circle, initially extends toward the inside of the drill tip, and negative if the second angle leg were to lag the lip rake face accordingly.

During the circular milling, which occurs after the drilling by means of the drill tip, the thread milling portion produces a thread in a wall of the drilled hole, said wall having been produced by the drill tip.

According to one development of the drill thread milling cutter, the at least one positive radial lip rake angle lies in the range of 3° to 12°, preferably of 5° to 10°. If the at least one positive radial lip rake angle lies in the range of 3° to 12°, preferably of 5° to 10°, the chips are broken particularly short, while at the same time the lip is sufficiently resistant to cutting-edge breakouts when materials that produce long chips are machined.

Preferably, the radial lip rake angle of each lip rake face is positive and lies in the range of 3° to 12°, preferably of 5° to 10°. The radial lip rake angles are preferably of equal magnitude.

According to one development of the drill thread milling cutter, at least the lip rake face of the lip rake faces that reaches the lip cutting circle at the at least one positive radial lip rake angle in a viewing direction parallel to the axis of rotation reaches the lip cutting circle with concave curvature in a viewing direction parallel to the axis of rotation. The concavely curved lip rake face draws the chip into the flute during drilling, so that the fragments of the chip are very quickly transported away by the engagement of the lip. Preferably, each lip rake face is concavely curved in a viewing direction parallel to the axis of rotation. Preferably, each lip rake face of the lip rake faces reaches the lip cutting circle with concave curvature in a viewing direction parallel to the axis of rotation.

According to one development of the drill thread milling cutter, at least the lip of the lips whose lip rake face reaches the lip cutting circle at the at least one positive radial lip rake angle in a viewing direction parallel to the axis of rotation reaches the lip cutting circle with a chamfer, in a viewing direction perpendicular to the axis of rotation, and thus forms a chamfered lip. The chamfered lip makes the drill tip shorter in the axial direction with respect to the axis of rotation and more stable and additionally ensures that no breakouts or at least fewer breakouts occur at the lip in the region of the lip cutting circle. Preferably, each lip of the lips is similarly chamfered.

According to one development of the drill thread milling cutter, the chamfered lip is chamfered at a chamfer angle in the range of 55° to 65°, wherein the chamfer angle is defined in a longitudinal section by the chamfered lip, where said lip is chamfered, and the axis of rotation, wherein the longitudinal section contains the chamfered lip and the axis of rotation, wherein the chamfer angle is measured on the side of the axis of rotation. If the chamfer angle lies in the range of 55° to 65°, the milling forces during circular milling are reduced particularly well. Preferably, each lip is similarly chamfered at a chamfer angle in the range of 55° to 65°.

According to one development of the drill thread milling cutter, the drill tip has three thinnings, by means of each of which a center cutting edge of the drill tip is formed, wherein each center cutting edge of the center cutting edges reaches one lip of the lips at an edge angle, wherein the edge angle is defined, in each case in a viewing direction parallel to the axis of rotation, by the center cutting edge and the lip where the center cutting edge reaches the lip, wherein at least one edge angle of the edge angles is an obtuse edge angle.

The three thinnings have the result that the drill tip has a pyramidal chisel-edge region which improves the behavior of the drill tip during the start of drilling. The initial contact between a material to be machined and the drill tip thus occurs more precisely. As soon as the drill tip penetrates into the material, the process forces act on the edges of the chisel edges of the pyramidal chisel-edge region and additionally support the self-centering ability of the drill tip. Therefore, pushing away can be avoided even on uneven surfaces.

The edge angles each have a first angle leg, which is a tangent of the center cutting edge where the center cutting edge reaches a center-cutting-edge cutting circle defined with respect to the center cutting edges; the center-cutting-edge cutting circle is centrally penetrated by the axis of rotation. The edge angles each have a second angle leg, which is a tangent of the lip where the lip reaches the center-cutting-edge cutting circle. The edge angles are measured on the side of front flank faces of the drill tip which are respectively associated with the center cutting edges.

The obtuse edge angle lies, because it is obtuse, in the range of greater than 90° to less than 180°, preferably of 140° to 160°. The obtuse edge angle improves the breaking of chips at the transition from the lip to the center cutting edge.

According to one development of the drill thread milling cutter, in a viewing direction parallel to the axis of rotation at least one center cutting edge of the center cutting edges reaches, with a straight extent, the lip of the lips whose lip rake face reaches the lip cutting circle at the at least one positive radial lip rake angle in a viewing direction parallel to the axis of rotation. The at least one straight center cutting edge can be produced particularly easily and thus economically by grinding of the drill tip and, at the same time, provides for particularly precise centering of the drill tip.

The center cutting edges of the center cutting edges normally reach, in a viewing direction parallel to the axis of rotation, a center-cutting-edge cutting circle which is centrally penetrated by the axis of rotation and which has a smaller diameter than the lip cutting circle.

The flutes normally reach a core circle in the radial direction from outside toward radially inside in a viewing direction parallel to the axis of rotation, wherein the core circle is centrally penetrated by the axis of rotation. The drill thread milling cutter thus normally has a lip cutting circle and a core circle, wherein the diameter of the core circle is normally at least 20% to at most 40% of the diameter of the lip cutting circle, preferably 25% to 35%. Because the chips are broken better as a result of the at least one positive radial lip rake angle, the diameter of the core circle can be up to at most 40% of the diameter of the lip cutting circle, because even then the volume of the flutes is still sufficient for transporting the chips away since the chips are broken short. An enlargement of the diameter of the core circle is desirable, because as a result the stability of the thread milling portion is improved, which also contributes to the increase in the advancing speed.

According to one development of the drill thread milling cutter, at least the lip of the lips whose lip rake face reaches the lip cutting circle at the at least one positive radial lip rake angle in a viewing direction parallel to the axis of rotation bends, with edge formation, from a center cutting edge of the center cutting edges in a viewing direction parallel to the axis of rotation. As a result, the chips break even more easily, and the situation in which the chips are produced as a relatively wide spiral strip that can lodge itself in the flutes and/or in the thread milling teeth is avoided even more effectively. Preferably, each lip of the lips similarly bends from a center cutting edge of the center cutting edges.

According to one development of the drill thread milling cutter, at least the flute of the flutes to which the lip rake face that reaches the lip cutting circle at the at least one positive radial rake angle in a viewing direction parallel to the axis of rotation is connected rises spirally at a pitch angle on the axis of rotation, wherein the pitch angle lies in the range of 5° to 25°, preferably of 10° to 20°, which includes, in each case, a preferred pitch angle of 15°. The spiral flute improves the transporting away, in the axial direction with respect to the axis of rotation, of the chips broken by the lip rake face which reaches, in a direction of view parallel to the axis of rotation, the lip cutting circle at the at least one positive radial rake angle. Preferably, each flute similarly rises spirally. The pitch angle is defined in a viewing direction perpendicular to the axis of rotation by the axis of rotation and by a flute tangent, wherein the flute tangent is a tangent of a curve following the flute and the pitch angle is measured on the side of the axis of rotation. The curve thus follows an edge of the flute. The pitch angle, which lies in the range of 5° to 25°, preferably of 10° to 20°, may be constant or variable. If the pitch angle is constant, it preferably lies in the range of 10° to 20°, which preferably includes 15°.

According to one development of the drill thread milling cutter, the thread milling teeth do not reach the lip cutting circle in a viewing direction parallel to the axis of rotation. As a result, during drilling the thread milling teeth are protected by the drill tip from contact with the workpiece.

According to one development of the drill thread milling cutter, the drill tip and the thread milling portion are a monolithic unit. As a result, an arrangement of the drill tip relative to the thread milling portion, which is set once, is better maintained, for example by virtue of the drill tip and the thread milling portion being produced from a common raw material bar by grinding.

According to one development of the drill thread milling cutter, each radial lip rake angle of the radial lip rake angles is positive. As a result, the advantages described with respect to the at least one positive radial lip rake angle are similarly achieved at the other lips.

According to one development of the drill thread milling cutter, each positive radial lip rake angle of the radial lip rake angles lies in the range of 3° to 12°, preferably of 5° to 10°. As a result, the advantages described with respect to the at least one positive radial lip rake angle, regarding its preferred angle ranges, are similarly achieved at the other lips.

According to one development of the drill thread milling cutter, the number of lips of the lips is limited to three. In particular if each radial lip rake angle of the radial lip rake angles is positive, a sufficient advancing speed can be achieved with just three lips. The production costs of the drill thread milling cutter can thus be reduced in comparison with production with more than three lips.

According to one development of the drill thread milling cutter, the number of flutes of the flutes is limited to three. In particular if each radial lip rake angle of the radial lip rake angles is positive, three flutes are sufficient for transporting away the chips produced during the drilling of materials that produce long chips, without the thread milling teeth being exposed to an increased risk of collision with respect to these chips. The production costs of the drill thread milling cutter can thus be reduced in comparison with production with more than three flutes.

According to one development, the drill thread milling cutter has an internal coolant channel structure, which has at least one coolant outlet in the drill tip at a plurality of lip flank faces, each lip flank face being associated, at the front, with one of the lips, and/or one coolant outlet in one of the flutes of the flutes. If the coolant outlet is formed and arranged in the drill tip at the lip flank faces, chips are better transported out of a drilling base during drilling. If the coolant outlet is formed and arranged in one of the flutes of the flutes, the transporting away of chips in this flute is improved. Accordingly, it is particularly advantageous if the coolant outlet is formed and arranged in the drill tip at the lip flank faces and another coolant outlet is formed and arranged in one of the flutes of the flutes.

According to one development, the drill thread milling cutter has at least one countersink cutting edge, which is formed and arranged at an end of the thread milling portion that is rearward with respect to the drill tip. The countersink cutting edge produces a peripheral chamfer at an edge of the drilled hole at the end of the drilling process.

Additional advantages and expediencies of the invention are clear from the following description of an exemplary embodiment with reference to the enclosed figures.

The Figures Show:

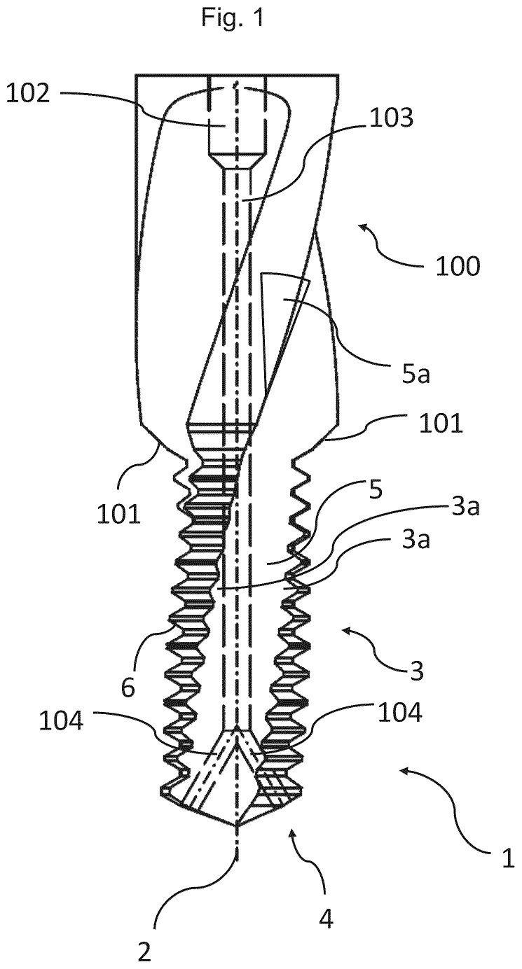

FIG. 1: a schematic illustration of a drill thread milling cutter in a side view;

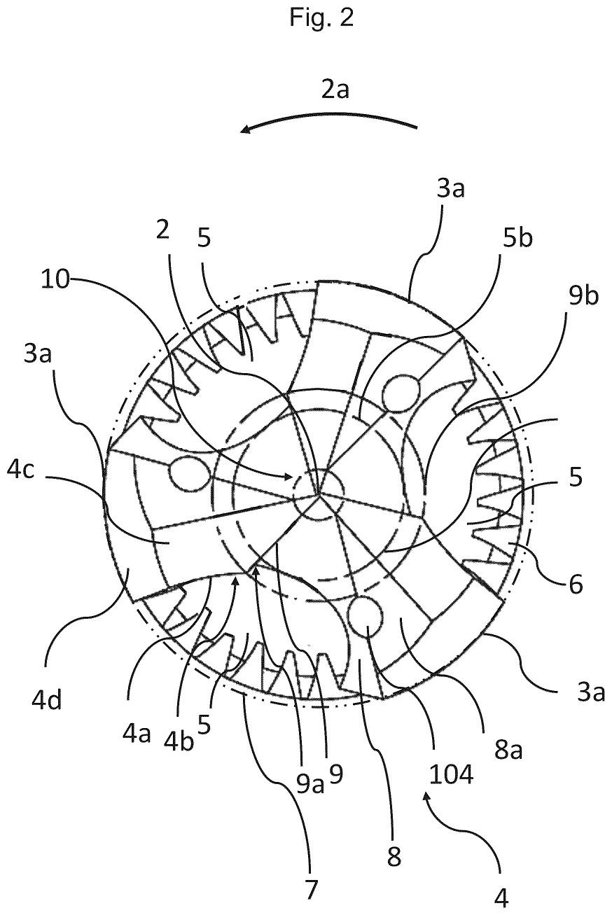

FIG. 2: a schematic illustration of the drill thread milling cutter according to FIG. 1 in a front view;

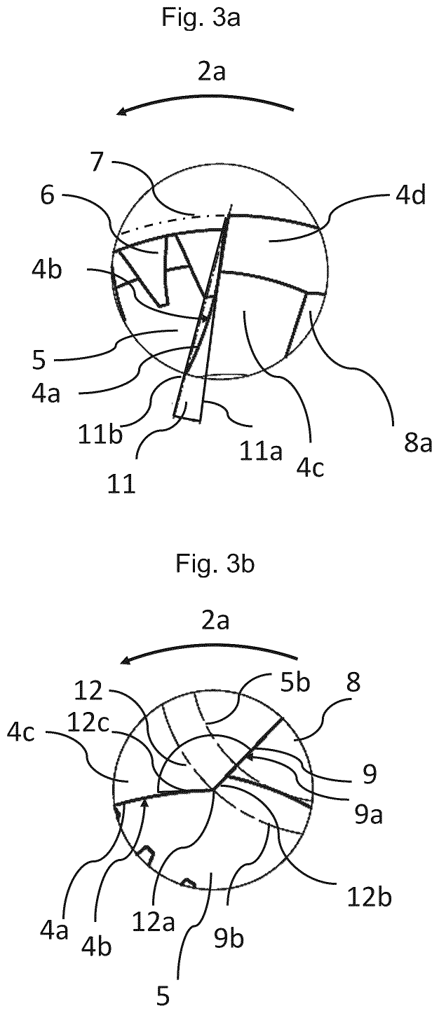

FIG. 3a: a schematic illustration of a detail from FIG. 2;

FIG. 3b: a schematic illustration of another detail from FIG. 2;

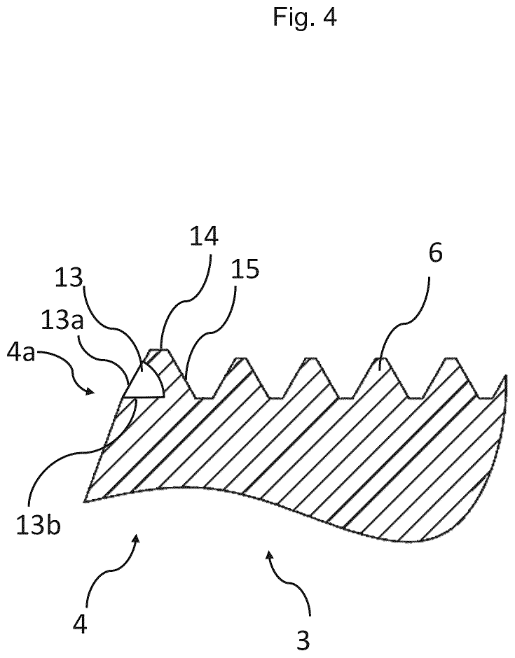

FIG. 4: a schematic longitudinal-section illustration of a front region of the drill thread milling cutter according to FIG. 1;

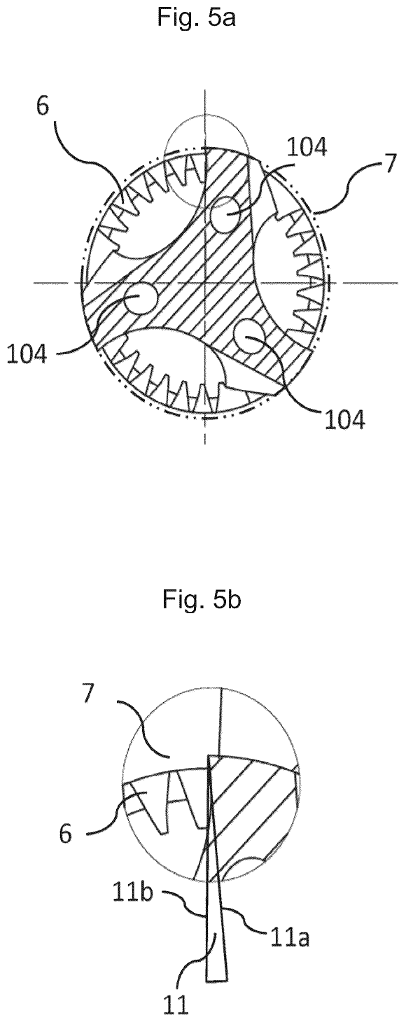

FIG. 5a: a schematic illustration of a cross section according to the section line V-V in FIG. 1;

FIG. 5b: a schematic illustration of a detail from FIG. 5a.

FIG. 1 shows a schematic illustration of a drill thread milling cutter 1 in a viewing direction perpendicular to an axis of rotation 2.

The drill thread milling cutter 1 extends along the axis of rotation 2 and has a thread milling portion 3 and a drill tip 4 adjoining the thread milling portion 3, wherein the thread milling portion 3 and the drill tip 4 are a monolithic unit which was ground from a round bar.

The thread milling portion 3 has three protrusions 3a, which each rise spirally with respect to the axis of rotation 2, as the combination of FIG. 1 and FIG. 2 shows. The protrusions 3a form the thread milling portion 3 and the drill tip 4 adjoining the thread milling portion 3. In the circumferential direction with respect to the axis of rotation 2, the protrusions 3a are spaced apart from one another, so that the thread milling portion 3 has three flutes 5, which each rise spirally at a flute angle 5a with respect to the axis of rotation 2 and thus reach the drill tip 4. The flute angle 5a can also be called the spiral angle.

The flute angle 5a is defined by a tangent applied to an edge curve of each flute 5 and by the axis of rotation 2; the flute angle 5a shown can be enlarged true to angle such that its angle leg on the side of the axis of rotation 2 coincides with the angle of rotation 2, wherein the other angle leg is the applied tangent. The flute angle 5a is, by way of example, 15° and thus lies in the range of 5° to 25° and also in the narrower range of 10° to 20°.

The thread milling portion 3 also has a plurality of thread milling teeth 6, which do not have a thread pitch.

The drill thread milling cutter 1 produces a drilled hole in a workpiece by means of the drill tip 4 in the following manner: the drill tip 4 is rotationally driven with respect to the axis of rotation 2 and, in the axial direction with respect to the axis of rotation 2, is axially plunged into a workpiece until a desired drilling depth in the workpiece is reached.

The drill thread milling cutter 1 produces a thread in the drilled workpiece by means of the thread milling portion 3 in the following manner: the drill thread milling cutter 1, in the plunged state, is radially plunged into the workpiece in the radial direction with respect to the axis of rotation 2 while still being rotationally driven. During the radial plunging, first the drill tip 4 plunges radially into the drilled workpiece, followed by the thread milling teeth 6 with simultaneous axial movement of the drill thread milling cutter 1 out of the drilled hole, so that the drill thread milling cutter 1 is removed from the drilled workpiece along a helical curve, while the thread milling teeth 6 are in contact with the drilled workpiece, and in the process performs a 360° rotation with respect to the axis of rotation 2. When the 360° rotation is completed, the thread has been completely produced. After the thread has been completely produced, the drill thread milling cutter 1 is radially retracted to the center of the drilled hole and is axially removed from the drilled hole.

The drill thread milling cutter 1 also has an end portion 100, into which the flutes 5 extend. The end portion 100 also has three countersink cutting edges 101, which produce an all-around chamfer in the drilled workpiece when the drill thread milling cutter 1 reaches the drilling depth.

The drill thread milling cutter 1 also has a feed-in channel 102 in the end portion 100. The feed-in channel 102 leads into a coolant main channel 103. The coolant main channel 103 extends in the end portion 100 and in the thread milling portion 3. In the thread milling portion 3, the coolant main channel 103 leads into three discharge channels 104, which extend in the thread milling portion 3 and in the drill tip 4. The discharge channels 104 each include with the axis of rotation 2 an acute angle measured on the side of the drill tip 4 and provide for a discharge of coolant from the drill tip 4. The coolant main channel 103 and the feed-in channel 102 each extend parallel and centrally with respect to the axis of rotation 2.

FIG. 2 shows the drill tip 4 in a viewing direction parallel to the axis of rotation 2 in a front view. The drill tip 4 has three lips 4a which each reach, with concave curvature, a lip cutting circle 7 in a viewing direction parallel to the axis of rotation 2; for reasons of clarity, in FIG. 2 only the lip at the approximately 8-o'clock position is provided with the reference sign 4a. The lip cutting circle 7 is centrally penetrated by the axis of rotation 2 and defines a drilling diameter that the drill tip 4 produces in the workpiece during the described drilling.

Each lip 4a has a lip rake face 4b which is connected to one of the flutes 5, as the combination of FIG. 1 and FIG. 2 shows; for reasons of clarity, in FIG. 2 only the lip rake face at the approximately 8-o'clock position is provided with the reference sign 4b, and the same applies, mutatis mutandis, to the flute 5. Each lip rake face 4b follows its lip 4a in a viewing direction parallel to the axis of rotation 2, so that each lip rake face 4b reaches, likewise with concave curvature, the lip cutting circle 7.

FIG. 2 also shows that the drill tip 4 has three thinnings 8 which are each in the form of a ground facet 8, each thinning lying opposite one of the lips 4a in a cutting-active direction of rotation 2a of the drill tip 4; for reasons of clarity, in FIG. 2 only the thinning in the region of a 6-o'clock position is provided with the reference sign 8.

By means of each thinning 8, a center cutting edge 9 is formed which reaches, with a straight extent, one of the lips 4a in a viewing direction parallel to the axis of rotation 2, so that the lip 4a bends, with edge formation, from its respective center cutting edge 9 oppositely to the cutting-active direction of rotation 2a, wherein the edge formation occurs on a center-cutting-edge cutting circle 9b.

Each center cutting edge 9 has a center-cutting-edge rake face 9a which reaches, with a straight extent, one of the lip rake faces 4b in a viewing direction parallel to the axis of rotation 2. The center cutting edges 9 reach the center-cutting-edge cutting circle 9b in a viewing direction parallel to the axis of rotation 2, the center-cutting-edge cutting circle being centrally penetrated by the axis of rotation 2 and making up approximately 40% of the lip cutting circle 7, which lies in the range of 30% to 50% with respect to this size ratio of the center-cutting-edge cutting circle 9b to the lip cutting circle 7 and thus is a relative measure of the size of the lips 4a relative to the size of the center cutting edges 9 in a viewing direction parallel to the axis of rotation 2. The thinnings 8 reduce an originally larger chisel-edge region 10 of the drill tip 4. The chisel-edge region 10 is pyramidal, is centrally penetrated by the axis of rotation 2 and connects the center cutting edges 9 to one another.

FIG. 2 also shows that each lip 4a has a radially inner front flank face 4c which the lip shares with the center cutting edge 9 associated with the lip. Each lip 4a also has a radially outer front flank face 4d, since each lip 4a is chamfered on the side of the lip cutting circle 7, so that in the region of the radially outer flank face 4d the lip 4a bends axially toward the thread milling portion 3.

FIG. 2 also shows that the drill tip 4 has three other ground flank faces 8a, which each adjoin, with radial edge formation, one of the thinnings 8, wherein the discharge channels 104 are each arranged between one of the other flank faces 8a and one of the thinnings 8 outside of the center-cutting-edge cutting circle 9b, so that it is ensured that coolant is discharged in the region of the flutes 5 in a viewing direction parallel to the axis of rotation 2.

FIG. 2 also shows that, in a viewing direction parallel to the axis of rotation 2, the flutes 5 extend from radially outside toward radially inside such that the flutes 5 reach a core circle 5b, which is centrally penetrated by the axis of rotation 2. The diameter of the center-cutting-edge cutting circle 9b is greater than the diameter of the core circle 5b, so that the center cutting edges 9 consequently protrude beyond the core circle 5b in a viewing direction parallel to the axis of rotation 2 and thus are cutting-active, at least in parts, in the region of the flutes 5.

FIG. 3a shows an enlarged detail of FIG. 2 where one of the lips 4a reaches, with concave curvature, the lip cutting circle 7, by way of example for all lips 4a.

FIG. 3a shows that the lip rake face 4b reaches the lip cutting circle 7 at a radial lip rake angle 11, wherein the lip rake angle 11 is drawn in as it is oriented and arranged in the cross section according to FIG. 5b.

The radial lip rake angle 11 has a first angle leg 11a, which is a tangent of the lip rake face 4b where the lip rake face 4b touches the lip cutting circle 7 in a viewing direction parallel to the axis of rotation 2. The radial lip rake angle 11 has a second angle leg 11b, which is oriented such that its radial extension with respect to the axis of rotation 2 would intersect the axis of rotation 2 perpendicularly to the axis of rotation.

The radial lip rake angle 11 is, according to the common convention, positive, because the second angle leg 11b leads, with respect to the cutting-active direction of rotation 2a, the lip rake face 4b where the lip rake face 4b, coming from the point at which it touches the lip cutting circle 7, initially extends toward the inside of the drill tip 4. The lip rake angle 11 is, by way of example, 6.5°, which lies in the range of 3° to 12° and in the range of 5° to 10°.

FIG. 3b shows another enlarged detail of FIG. 2 where one of the lips 4a bends at an obtuse edge angle 12 from one of the center cutting edges 9, by way of example for all lips 4a and center cutting edges 9.

The point 12a of the obtuse edge angle 12 lies on the center-cutting-edge cutting circle 9b in a viewing direction parallel to the axis of rotation 2. The obtuse edge angle 12 has a first angle leg 12b, which is a tangent of the center cutting edge 9 where the center cutting edge 9 reaches the center-cutting-edge cutting circle 9b. The obtuse edge angle 12 has a second angle leg 12c, which is a tangent of the lip 4a where the lip 4a reaches the center-cutting-edge cutting circle 9b. The obtuse edge angle 12 is measured on the side of the flank face 4c and, because it is obtuse, lies in the range of greater than 90° to less than 180°, preferably of 140° to 160°. With respect to the cutting-active direction of rotation 2a, the center cutting edge 9 runs ahead of the lip 4a that it reaches.

FIG. 4 shows a longitudinal section of the drill thread milling cutter 1 in the region of the drill tip 4 and of the thread milling portion 3 where the drill tip 4 adjoins the thread milling portion 3. The longitudinal section contains the axis of rotation 2. The viewing direction in FIG. 4 is perpendicular to the axis of rotation 2.

In FIG. 4 it is clear, by way of example for each of the lips 4a, that the lips 4a are chamfered at a chamfer angle 13 in a viewing direction perpendicular to the axis of rotation 2 and thus, as is clear from the combination of FIG. 1 and FIG. 2, reach the lip cutting circle 7. In the longitudinal section according to FIG. 4, the chamfer angle 13 has a first angle leg 13a, which is a tangent of the lip 4a where it is chamfered. The chamfer angle 13 has a second angle leg 13b, which runs parallel to the axis of rotation 2; the chamfer angle 13 can be enlarged true to angle such that the second angle leg 13b coincides with the axis of rotation 2 or that the axis of rotation 2 forms the second angle leg. The chamfer angle 13 is measured on the side of the thread milling portion 3 and is, by way of example, 60°, which lies in the range of 55° to 65°.

In FIG. 4 it is also clear, by way of example for each of the lips 4a, that each lip 4a is assigned a drilling lateral cutting edge 14, wherein each drilling lateral cutting edge 14 extends parallel to the axis of rotation 2 and is shorter, in the axial direction with respect to the axis of rotation 2, than the lip 4a to which it is assigned.

In FIG. 4 it is also clear, by way of example for each of the drilling lateral cutting edges 14, that the drilling lateral cutting edges 14 adjoin, on the side of the thread milling portion 3, a rearward cutting edge 15 of the drill tip 4.

In FIG. 4 it is also clear, by way of example for each of the lips 4a, that the lips 4a protrude beyond the thread milling teeth 6 in the radial direction. In other words, the thread milling teeth 6 do not reach the lip cutting circle 7.

In FIG. 4 it is also clear, by way of example for each thread milling tooth 6, that the thread milling teeth 6 have a trapezoidal profile in the longitudinal section according to FIG. 4.

FIGS. 1, 2, 3a, 3b and 4 show a drill thread milling cutter 1 that is particularly well suited to the machining of materials that produce long chips, because the three lips 4a formed in the region of the drill tip 4 each have a lip rake face 4b which reaches the lip cutting circle 7 at a positive lip rake angle 11 and which thus breaks the chips shorter. The concave shape of each of the lip rake faces 4b, with which concave shape each of the lip rake faces reaches the lip cutting circle 7, more strongly draws the broken chips into the flutes 5. Since the lips 4a are chamfered at the chamfer angle 13, the forces produced during thread milling are reduced and the stability of the lip 4a in the region of the lip cutting circle 7 is increased.

The thinnings 8 shorten the otherwise larger chisel-edge region 10, and this improves the centering of the drill tip 4. Since the edge formation between the center cutting edges 9 and the lips 4a occurs with the obtuse edge angle 12, the chips are more heavily broken. In comparison with two lips, the drill thread milling cutter 1 has, because of the three lips 4a, a greater advancing speed which is increased as a result of the improved breaking of chips.

Although the coolant supply described with respect to FIG. 1 and FIG. 2 and the countersink cutting edges 101 improve the performance capability of the drill thread milling cutter 1 individually and in combination with one another, they are optional individually and in combination with one another. This should not exclude the possibility of other features of the drill thread milling cutter 1 also being optional, which is to be assessed in each individual case in light of the use in drilling and/or thread milling and in light of the properties required for said use.

FIG. 5a shows, in a schematic illustration, a cross section of the drill thread milling cutter 1 according to the section line V-V in FIG. 1 and in a viewing direction of the arrows associated with this section line in FIG. 1. The circle arranged at 12 o'clock in FIG. 5a encircles the cross section region shown enlarged in FIG. 5b.

In FIG. 5b the lip rake angle 11 is drawn in as it is usually measured, namely in a cross section which is oriented and arranged according to the section line V-V from FIG. 1. The lip rake angle 11 is, according to the common convention, positive, which can also be described as “acute angle”.

Because the lip rake angle 11 is positive, the chips removed by the lip 4a are drawn from radially outside, i.e. where the point of the lip rake angle 11 touches the lip cutting circle 7 in the cross section according to FIG. 5a, into the lip rake face 4b, whereby the chips are cleared away from the region of the lip cutting circle 7.

1-15. (canceled)

16. A drill thread milling cutter extending along an axis of rotation, the drill thread milling cutter comprising:
a thread milling portion having three flutes and a plurality of thread milling teeth; and
a drill tip adjoining said thread milling portion, said drill tip having three lips which each reach a lip cutting circle in a viewing direction parallel to the axis of rotation, wherein said lip cutting circle defines a drilling diameter that is produced by said drill tip, wherein each of said lips has a lip rake face which is connected to one flute of said flutes and which reaches said lip cutting circle at a radial lip rake angle in a viewing direction parallel to the axis of rotation, wherein at least one said radial lip rake angle of radial lip rake angles is positive, namely being at least one positive radial lip rake angle.

17. The drill thread milling cutter according to claim 16, wherein said at least one positive radial lip rake angle lies in a range of 3° to 12°.

18. The drill thread milling cutter according to claim 16, wherein at least said lip rake face of said lip rake faces that reaches said lip cutting circle at the at least one positive radial lip rake angle in the viewing direction parallel to the axis of rotation reaches the lip cutting circle with concave curvature in the viewing direction parallel to the axis of rotation.

19. The drill thread milling cutter according to claim 16, wherein at least said lip of said lips whose said lip rake face reaches said lip cutting circle at said at least one positive radial lip rake angle in the viewing direction parallel to the axis of rotation reaches the lip cutting circle with a chamfer, in a viewing direction perpendicular to the axis of rotation, and thus forms a chamfered lip.

20. The drill thread milling cutter according to claim 19, wherein said chamfered lip is chamfered at a chamfer angle in a range of 55° to 65°, wherein the chamfer angle is defined in a longitudinal section by said chamfered lip, where said lip is chamfered, and the axis of rotation is clamped, wherein the longitudinal section contains said chamfered lip and the axis of rotation, wherein the chamfer angle is measured on a side of the axis of rotation.

21. The drill thread milling cutter according to claim 16, wherein said drill tip has three thinnings, by means of each of said thinnings a center cutting edge of said drill tip is formed, wherein each said center cutting edge of center cutting edges reaches one said lip of said lips at an edge angle, wherein the edge angle is defined, in each case in the viewing direction parallel to the axis of rotation, by said center cutting edge and said lip where said center cutting edge reaches said lip, wherein at least one said edge angle of edge angles is an obtuse edge angle.

22. The drill thread milling cutter according to claim 21, wherein in the viewing direction parallel to the axis of rotation at least one said center cutting edge of said center cutting edges reaches, with a straight extent, said lip of said lips whose said lip rake face reaches the lip cutting circle at said at least one positive radial lip rake angle in the viewing direction parallel to the axis of rotation.

23. The drill thread milling cutter according to claim 21, wherein at least said lip of said lips whose said lip rake face reaches the lip cutting circle at said at least one positive radial lip rake angle in the viewing direction parallel to the axis of rotation bends, with edge formation, from said center cutting edge of said center cutting edges in the viewing direction parallel to the axis of rotation.

24. The drill thread milling cutter according to claim 16, wherein at least said flute of said flutes to which said lip rake face that reaches the lip cutting circle at the at least one positive radial lip rake angle in the viewing direction parallel to the axis of rotation is connected rising spirally at a pitch angle on the axis of rotation, wherein the pitch angle lies in the range of 5° to 25°.

25. The drill thread milling cutter according to claim 16, wherein said thread milling teeth do not reach the lip cutting circle in the viewing direction parallel to the axis of rotation.

26. The drill thread milling cutter according to claim 16, wherein said drill tip and said thread milling portion are a monolithic unit.

27. The drill thread milling cutter according to claim 16, wherein each said radial lip rake angle is positive.

28. The drill thread milling cutter according to claim 27, wherein each said positive radial lip rake angle of said radial lip rake angles lies in a range of 3° to 12°.

29. The drill thread milling cutter according to claim 16, wherein a number of said lips is limited to three.

30. The drill thread milling cutter according to claim 16, wherein a number of said flutes is limited to three.

31. The drill thread milling cutter according to claim 17, wherein said range of the at least one positive radial lip rake angle is 5° to 10°.

32. The drill thread milling cutter according to claim 24, wherein said range of the pitch angle is 10° to 20°.

33. The drill thread milling cutter according to claim 28, wherein said range is 5° to 10°.
